(19) United States
(12) Patent Application Publication
(10) Pub. No.: US 2023/0040352 A1
(43) Pub. Date: Feb. 9, 2023

(54) METAL DETECTING FOOTWEAR

(71) Applicant: Karl Beutelspacher, Vashon, WA (US)

(72) Inventor: Karl Beutelspacher, Vashon, WA (US)

(21) Appl. No.: 17/395,719

(22) Filed: Aug. 6, 2021

(51) Int. Cl. A43B 3/00; G01V 3/10

(52) U.S. Cl. CPC A43B 3/001; G01V 3/10

(57) ABSTRACT

Footwear articles including an upper, a sole, and a metal detecting system. The sole is secured to the upper and defines a cavity. The metal detecting system is secured to the sole in the cavity. In some examples, the footwear article includes an indicator.

### BACKGROUND

The present disclosure relates generally to footwear articles. In particular, metal detecting footwear is described.

Metal detecting is an activity done for useful endeavors and for recreation. When metal detecting, one searches an area for metal objects using a metal detector. Known metal detectors and approaches to metal detecting are not entirely satisfactory.

For example, existing metal detectors must be carried by hand, which limits a person's ability to use his or her hands for other purposes. Further, existing metal detectors are somewhat heavy and fatiguing. The length of existing metal detectors makes them awkward to carry and prone to getting caught in underbrush and trees when walking in nature with them.

The manner in which conventional metal detectors are used is another limiting feature of them. Existing metal detectors must be manually directed over the ground. The length of conventional metal detectors can make it difficult to direct the metal detector towards a desired location because branches, objects, and underbrush can obstruct the metal detector.

Having to actively direct the metal detector over the ground can become mentally fatiguing and inconvenient. It would be desirable to have a way to passively detect metal objects as one walks along the ground or through water without having to actively direct a metal detector over the ground.

Conventional metal detectors represent a separate item that must be brought along with a person if he or she wants to detect metal objects. It would be desirable if a person could detect metal objects without having to remember to bring and pack a distinct metal detector.

Thus, there exists a need for improvements in the field of metal detecting and in the design of known metal detectors. Examples of new and useful metal detecting footwear articles relevant to the needs existing in the field are discussed below.

### SUMMARY

The present disclosure is directed to footwear articles including an upper, a sole, and a metal detecting system. The sole is secured to the upper and defines a cavity. The metal detecting system is secured to the sole in the cavity. In some examples, the footwear article includes an indicator.

### BRIEF DESCRIPTION OF THE DRAWING

FIG. 1 is a view of a person wearing a pair of boots including a metal detecting system above a buried metal object

FIG. 2 is a side elevation view of the boot shown in FIG. 1 with a portion of a sole removed to depict the metal detecting system secured in a cavity of the sole.

FIG. 3 is a front perspective view of the metal detecting system shown in FIG. 2 on its own not installed in the sole of the boot.

FIG. 4 is a side elevation view of the metal detecting system shown in FIG. 2 on its own not installed in the sole of the boot.

FIG. 5 is a schematic view of a pulse induction type of metal detecting system.

FIG. 6 is a side elevation view of left and right sandals each including a metal detecting system.

FIG. 7 is a schematic view of a very low frequency type of metal detecting system.

FIG. 8 is a circuit diagram of a metal detecting system.

### DETAILED DESCRIPTION

The disclosed footwear articles will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various footwear articles are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

“Communicatively coupled” means that an electronic device exchanges information with another electronic device, either wirelessly or with a wire-based connector, whether directly or indirectly through a communication network.

“Controllably coupled” means that an electronic device controls operation of another electronic device.

Metal Detecting Footwear

With reference to the figures, metal detecting footwear will now be described. The footwear articles discussed herein function to detect metal objects.

The reader will appreciate from the figures and description below that the presently disclosed footwear articles address many of the shortcomings of conventional metal detectors and approaches to metal detecting. For example, the metal detecting footwear described herein does not need to be carried by hand like a conventional metal detector. As a result, the metal detecting footwear described below frees a user's hands for other purposes.

Further, the weight of the metal detecting systems in the footwear described below is low to the ground and borne by a person's legs rather than a person's hand and arms as occurs with conventional metal detectors. Leg muscles are stronger and more robust than arm and hand muscles; thus, the metal detecting footwear described herein is less fatiguing to carry and use than existing metal detectors.

The metal detecting systems incorporated into the footwear discussed below are compact and self-contained. Their compact and self-contained form makes them convenient to carry and helps avoid them getting caught in underbrush and trees when walking in nature with them.

The metal detecting footwear below does not need to be manually directed over the ground. As a result, the metal detecting footwear dispenses with the need to concentrate on directing a handheld metal detector and avoids the associated mental fatigue and inconvenience. Instead, the metal detecting footwear described herein desirably provides a way to passively detect metal objects as one walks along the ground without having to actively direct a metal detector over the ground.

Conveniently, one does not need to pack and remember to bring a distinct metal detector with the metal detecting footwear discussed in this document. Whenever one is wearing the footwear described below, he or she can selectively activate he metal detecting features of the footwear to detect metal objects when desired without requiring a separate device.

### Footwear Article Embodiment One

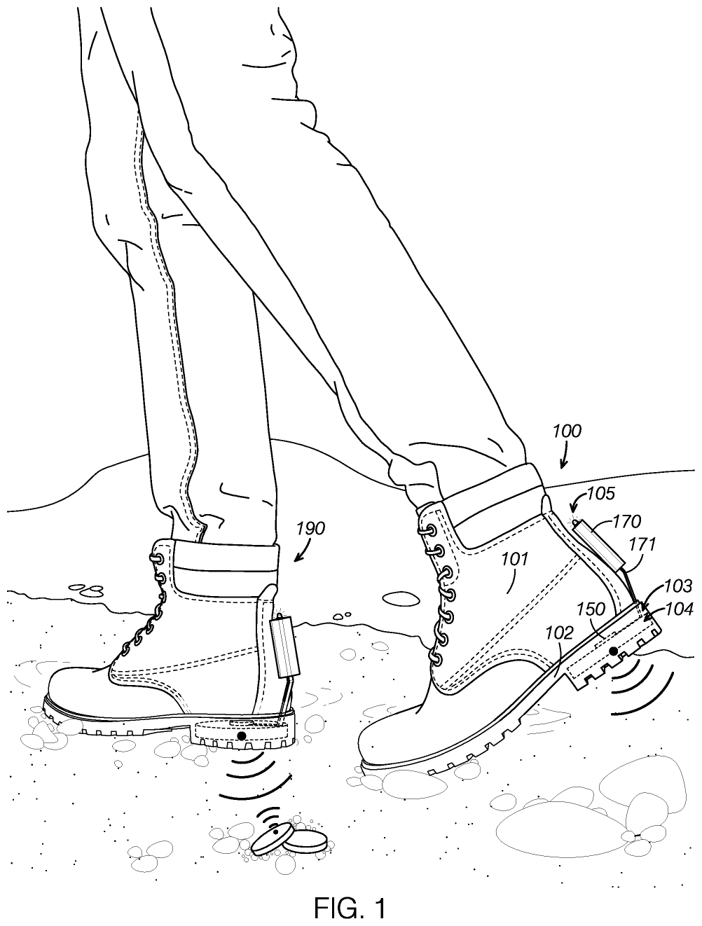

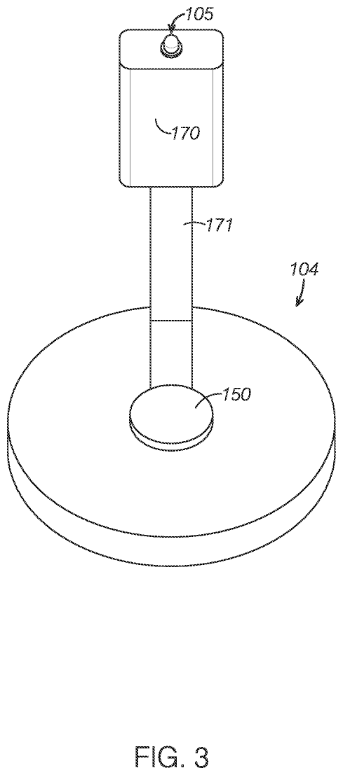

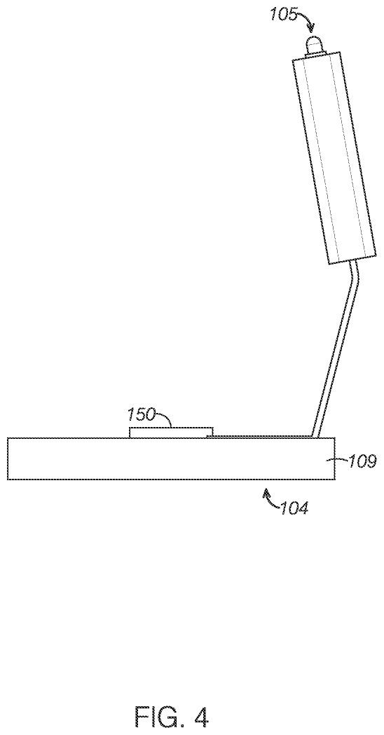

With reference to FIGS. 1-5, and 8, a footwear article 100 will now be described as a first example of a footwear article. As can be seen in FIG. 1, footwear article 100 is a first footwear article and a second footwear article 190 is also depicted. Second footwear article 190 is configured the same as first footwear article 100 except that it is configured to receive the other foot of the user.

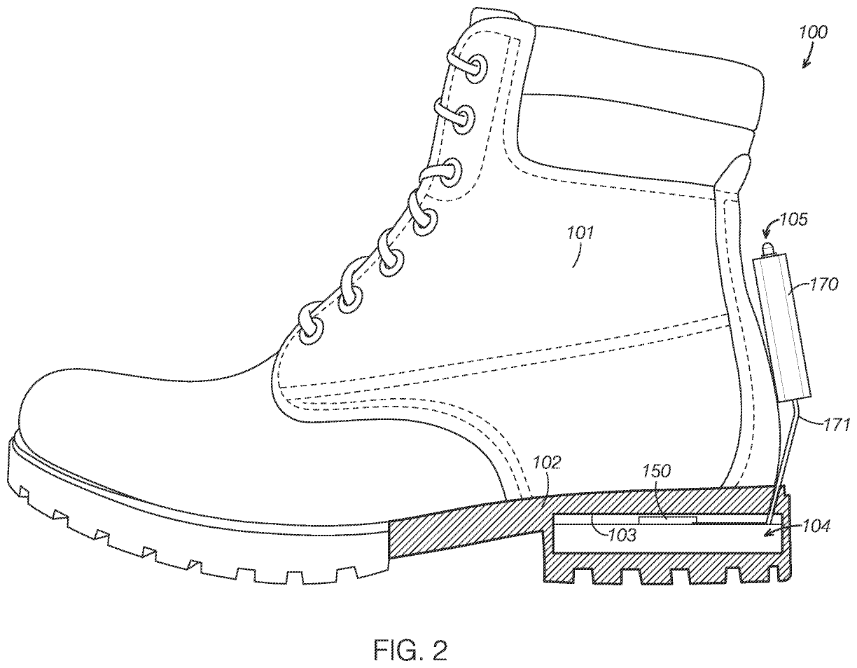

As shown in FIGS. 1 and 2, footwear article 100 includes an upper 101, a sole 102, a metal detecting system 104, a first indicator 105, and a second indicator 150. In other examples, the footwear article includes fewer components than depicted in the figures. In certain examples, the footwear article includes additional or alternative components than depicted in the figures.

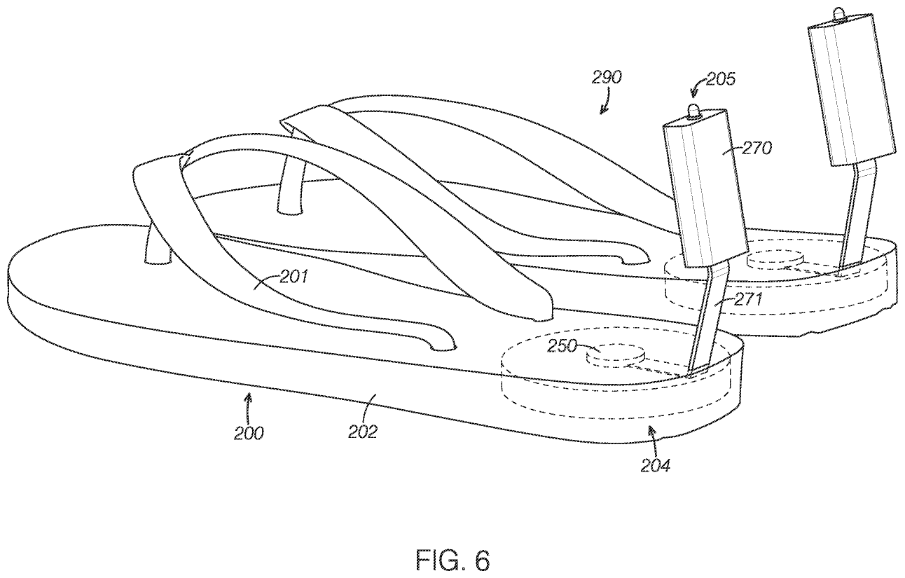

The reader can see in FIGS. 1 and 2 that footwear article 100 defines a boot. In other examples, such as depicted in FIG. 6 where the footwear article defines a sandal, the footwear article is a type of footwear other than a boot. For example, the footwear article may be a shoe, a boot, a sandal, or any other currently known or later developed type of footwear.

Sole

The role of sole 102 is to support upper 101 and to provide a durable surface on which to walk between upper 101 and the ground. Sole 102 also functions to house metal detecting system 104. As depicted in FIG. 2, sole 102 is secured to upper 101 and defines a cavity 103 in which metal detecting system 104 is partially disposed.

The sole may be any currently known or later developed type of sole. The reader will appreciate that a variety of sole types exist and could be used in place of the sole shown in the figures. In addition to the types of soles existing currently, it is contemplated that the footwear articles described herein could incorporate new types of soles developed in the future.

The size and shape of the sole may be varied as needed for a given application. In some examples, the sole is larger relative to the other components than depicted in the figures. In other examples, the sole is smaller relative to the other components than depicted in the figures. Further, the reader should understand that the sole and the other components may all be larger or smaller than described herein while maintaining their relative proportions.

In the present example, the sole is composed of rubber. However, the sole may be composed of any currently known or later developed material suitable for the applications described herein for which it is used. Suitable materials include metals, polymers, ceramics, wood, and composite materials.

Metal Detecting System

Metal detecting system 104 functions to detect metal objects near metal detecting system 104, such as under the surface of the ground or under water. With reference to FIGS. 1 and 2, a portion of metal detecting system 104 is secured to sole 102 in cavity 103 and the remaining components are housed in housing 170 outside of sole 102.

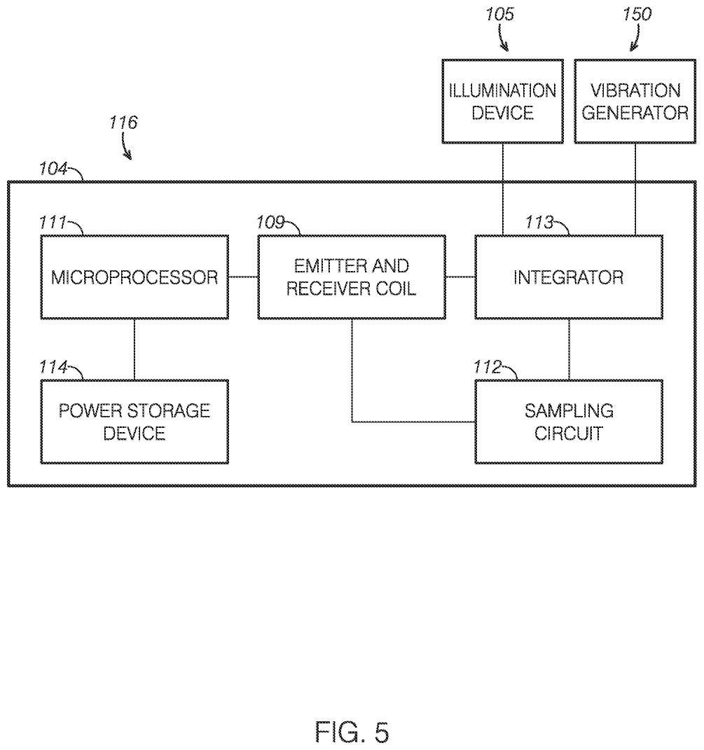

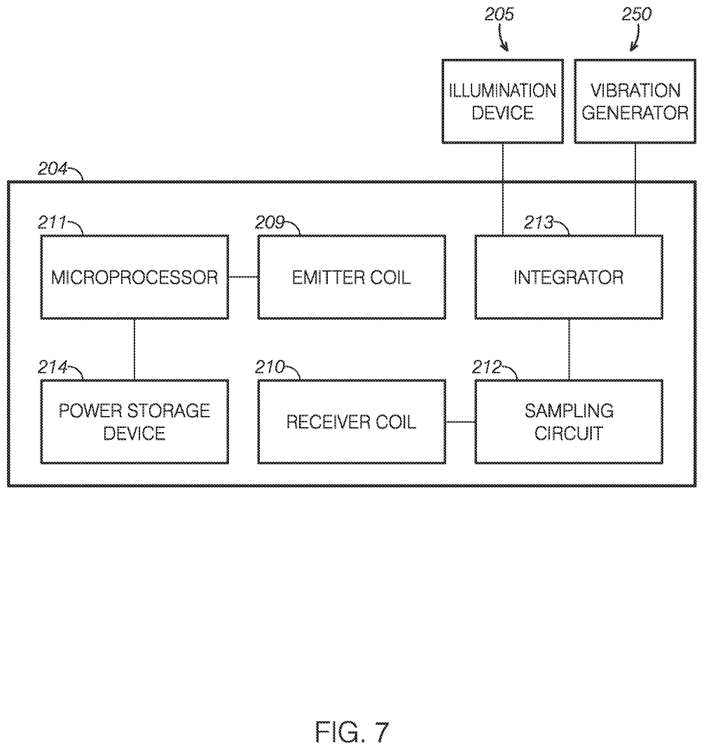

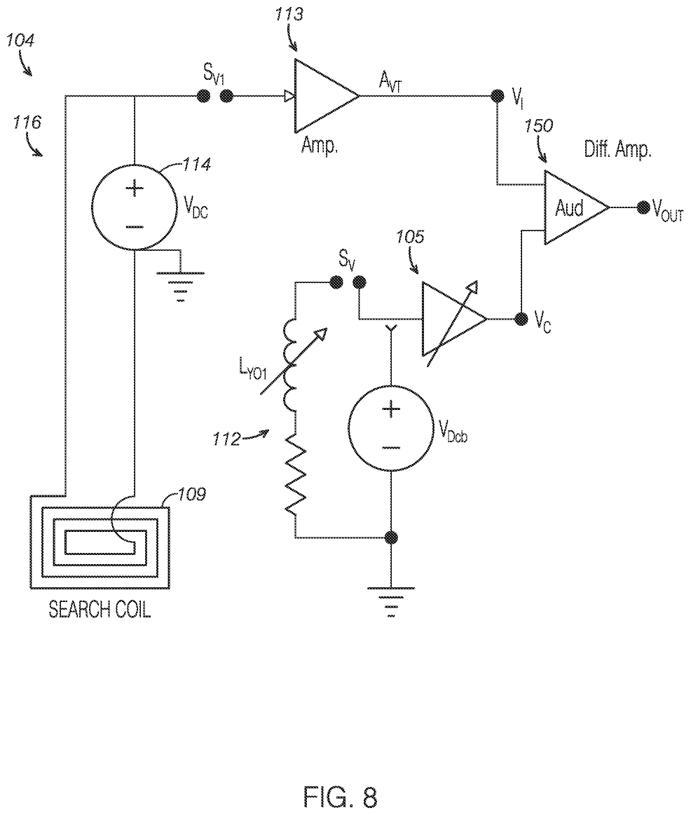

The reader can see in FIGS. 5 and 8 that metal detecting system 104 is a pulse induction system 116. However, the metal detecting system may be any currently known or later developed type of metal detecting system. The reader will appreciate that a variety of metal detecting system types exist and could be used in place of the metal detecting system shown in the figures. For example, as depicted in FIGS. 6 and 7, the metal detecting system may be a very low frequency type metal detecting system. In addition to the types of metal detecting systems existing currently, it is contemplated that the footwear articles described herein could incorporate new types of metal detecting systems developed in the future.

As shown in FIG. 5, metal detecting system 104 includes an emitter-and-receiver coil 109, a microprocessor 111, a sampling circuit 112, an integrator 113, a power storage device 114, a housing 170, and an arm 171. The components of metal detecting system 104 are described in more detail below. In the present example, emitter-and-receiver coil 109 is disposed in cavity 103 of sole 102 and the remaining components of metal detecting system 104 are housed in housing 170. Arm 171 links housing 170 to emitter-and-receiver coil 109.

The size and shape of the metal detecting system may be varied as needed for a given application. In some examples, the metal detecting system is larger relative to the other components than depicted in the figures. In other examples, the metal detecting system is smaller relative to the other components than depicted in the figures. Further, the reader should understand that the metal detecting system and the other components may all be larger or smaller than described herein while maintaining their relative proportions.

Microprocessor

Microprocessor 111 is configured to generate current pulses through emitter-and-receiver coil 109. In the particular example shown in FIGS. 1-5, microprocessor 111 is configured to generate at least one hundred current pulses per second through emitter-and-receiver coil 109. As depicted in FIG. 5, microprocessor 111 is communicatively coupled to emitter-and-receiver coil 109.

The microprocessor may be any currently known or later developed type of microprocessor. The reader will appreciate that a variety of microprocessor types exist and could be used in place of the microprocessor shown in the figures. In addition to the types of microprocessors existing currently, it is contemplated that the footwear articles described herein could incorporate new types of microprocessors developed in the future.

Sampling Circuit

Sampling circuit 112 functions to monitor reflected current pulses in emitter-and-receiver coil 109. Sampling circuit 112 is also configured to generate a signal current that signals when metal has been detected. Sampling circuit 112 generates a signal current based on the behavior of the reflected current pulses in emitter-and-receiver coil 109.

The sampling circuit may be any currently known or later developed type of sampling circuit. The reader will appreciate that a variety of sampling circuit types exist and could be used in place of the sampling circuit shown in the figures. In addition to the types of sampling circuits existing currently, it is contemplated that the footwear articles described herein could incorporate new types of sampling circuits developed in the future.

Integrator

Integrator 113 is configured to amplify the signal current into an amplified current. As shown in FIG. 5, integrator 113 is communicatively coupled to sampling circuit 112.

The integrator may be any currently known or later developed type of integrator. The reader will appreciate that a variety of integrator types exist and could be used in place of the integrator shown in the figures. In addition to the types of integrators existing currently, it is contemplated that the footwear articles described herein could incorporate new types of integrators developed in the future.

Power Storage Device

Power storage device 114 functions to supply power to the other components of metal detecting system 104. With reference to FIGS. 5 and 8, power storage device 114 is a battery.

The power storage device may be any currently known or later developed type of power storage device. The reader will appreciate that a variety of power storage device types exist and could be used in place of the power storage device shown in the figures. In addition to the types of power storage devices existing currently, it is contemplated that the footwear articles described herein could incorporate new types of power storage devices developed in the future.

The size and shape of the power storage device may be vaned as needed for a given application. In some examples, the power storage device is larger relative to the other components than depicted in the figures. In other examples, the power storage device is smaller relative to the other components than depicted in the figures. Further, the reader should understand that the power storage device and the other components may all be larger or smaller than described herein while maintaining their relative proportions.

Indicators

The role of first indicator 105 and second indicator 150 is to indicate when metal detecting system 104 detects metal. As shown in FIGS. 2-5, first indicator 105 and second indicator 150 are communicatively coupled to metal detecting system 104.

In particular, as shown in FIG. 5, first indicator 105 and second indicator 150 are communicatively coupled to integrator 113. With reference to FIG. 5, first indicator 105 and second indicator 150 are configured to indicate when metal detecting system 104 detects metal based on an amplified current from integrator 113.

The reader can see in FIGS. 2-5 that first indicator 105 is an illumination device 106. As depicted in FIGS. 2-5, second indicator 150 is a vibration generator 108. However, the indicators may be any currently known or later developed type of indicator, such as an audio device or a visual display. The reader will appreciate that a variety of indicator types exist and could be used in place of the indicators shown in the figures. In addition to the types of indicators existing currently, it is contemplated that the footwear articles described herein could incorporate new types of indicators developed in the future.

The number of indicators in the footwear article may be selected to meet the needs of a given application. The reader should appreciate that the number of indicators may be different in other examples than is shown in the figures. For instance, some footwear article examples include additional or fewer indicators than described in the present example.

The size and shape of the indicators may be varied as needed for a given application. In some examples, the indicators are larger relative to the other components than depicted in the figures. In other examples, the indicator are smaller relative to the other components than depicted in the figures. Further, the reader should understand that the indicators and the other components may all be larger or smaller than described herein while maintaining their relative proportions.

Illumination Device

Illumination device 106 functions to emit light when activated. The reader can see in FIGS. 2-5 that illumination device 106 is a light emitting diode. However, the illumination device may be any currently known or later developed type of illumination device. The reader will appreciate that a variety of illumination device types exist and could be used in place of the illumination device shown in the figures. In addition to the types of illumination devices existing currently, it is contemplated that the footwear articles described herein could incorporate new types of illumination devices developed in the future.

The size and shape of the illumination device may be varied as needed for a given application. In some examples, the illumination device is larger relative to the other components than depicted in the figures. In other examples, the illumination device is smaller relative to the other components than depicted in the figures. Further, the reader should understand that the illumination device and the other components may all be larger or smaller than described herein while maintaining their relative proportions.

### Additional Embodiments

With reference to the figures not yet discussed in detail, the discussion will now focus on additional footwear article embodiments. The additional embodiments include many similar or identical features to footwear article 100. Thus, for the sake of brevity, each feature of the additional embodiments below will not be redundantly explained. Rather, key distinctions between the additional embodiments and footwear article 100 will be described in detail and the reader should reference the discussion above for features substantially similar between the different footwear article examples.

### Footwear Article Embodiment Two

Turning attention to FIGS. 6 and 7, a footwear article 200 will now be described as a second example of a footwear article. As can be seen in FIGS. 6 and 7, footwear article 200 includes an upper 201, a sole 202, a metal detecting system 204, a first indicator 205, and a second indicator 250. In other examples, the footwear article includes fewer components than depicted in the figures. In certain examples, the footwear article includes additional or alternative components than depicted in the figures.

### Footwear Article Embodiment Two

As depicted in FIG. 6, footwear article 200 defines a sandal in contrast to footwear article 100 that defines a boot. Other types of footwear beyond boots and sandals, such as shoes, are contemplated. Upper 201 is a strap in the FIG. 6 example.

As can be seen in FIG. 7, footwear article 200 is a first footwear article and a second footwear article 290 is also depicted. Second footwear article 290 is configured the same as first footwear article 200 except that it is configured to receive the other foot of the user.

Metal Detecting System

With reference to FIGS. 6 and 7, metal detecting system 204 is a very low frequency system unlike metal detecting system 104, which is a pulse induction system. As shown in FIG. 7, metal detecting system 204 includes an emitter coil 209, a receiver coil 210, a microprocessor 211, a sampling circuit 212, an integrator 213, a housing 270, and an arm 271. The reader can see in FIG. 7 that emitter coil 209 and receiver coil 210 are separate coils in contrast to the single emitter-and-receiver coil 109 in embodiment one.

Microprocessor

As depicted in FIG. 7, microprocessor 211 is communicatively coupled to emitter coil 209. Microprocessor 211 is configured to generate current pulses through emitter coil 209.

Sampling Circuit

With reference to FIG. 7, sampling circuit 212 monitors reflected current pulses in receiver coil 210. Sampling circuit 212 is configured to generate a signal current that signals when metal has been detected. Sampling circuit 212 generates the signal current based on the behavior of the reflected current pulses in receiver coil 210.

Integrator

As shown in FIG. 7, integrator 213 is communicatively coupled to sampling circuit 212. Integrator 213 is configured to amplify the signal current into an amplified current.

Indicator

The reader can see in FIGS. 6 and 7 that first indicator 205 and second indicator 250 are communicatively coupled to metal detecting system 204. First indicator 205 and second indicator 250 are configured to indicate when metal detecting system 204 detects metal.

The disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

1. A footwear article, comprising:
an upper;
a sole secured to the upper and defining a cavity;
a metal detecting system secured to the sole in the cavity.

2. The footwear article of claim 1, further comprising an indicator communicatively coupled to the metal detecting system and configured to indicate when the metal detecting system detects metal.

3. The footwear article of claim 2, wherein the indicator is an illumination device.

4. The footwear article of claim 3, wherein the illumination device is a light emitting diode.

5. The footwear article of claim 2, wherein the indicator is a vibration generator.

6. The footwear article of claim 1, wherein the footwear article defines a sandal.

7. The footwear article of claim 1, wherein the metal detecting system includes an emitter-and-receiver coil.

8. The footwear article of claim 7, wherein the metal detecting system includes a microprocessor communicatively coupled to the emitter-and-receiver coil and configured to generate current pulses through the emitter-and-receiver coil.

9. The footwear article of claim 8, wherein the microprocessor is configured to generate at least one hundred current pulses per second through the emitter-and-receiver coil.

10. The footwear article of claim 8, wherein the metal detecting system includes a sampling circuit monitoring reflected current pulses in the emitter-and-receiver coil and configured to generate a signal current that signals when metal has been detected based on the behavior of the reflected current pulses in the emitter-and-receiver coil.

11. The footwear article of claim 10, wherein the metal detecting system includes an integrator communicatively coupled to the sampling circuit and configured to amplify the signal current into an amplified current.

12. The footwear article of claim 11, wherein:
further comprising an indicator communicatively coupled to the metal detecting system;
the indicator is communicatively coupled to the integrator; and
the indicator is configured to indicate when the metal detecting system detects metal based on the amplified current from the integrator.

13. The footwear article of claim 6, wherein the metal detecting system includes a power storage device configured to supply power to the metal detecting system.

14. The footwear article of claim 13, wherein the power storage device is a battery.

15. The footwear article of claim 1, wherein the footwear article defines a boot.

16. The footwear article of claim 1, wherein the metal detecting system is a pulse induction system.

17. A footwear pair comprising:
a first footwear article configured to be worn on a left foot, the first footwear article including:
an upper;
a sole secured to the upper and defining a cavity;
a metal detecting system secured to the sole in the cavity;
a second footwear article configured to be worn on a right foot and otherwise configured the same as the first footwear article.

18. The footwear pair of claim 17, wherein the first footwear article includes an indicator communicatively coupled to the metal detecting system and configured to indicate when the metal detecting system detects metal.

19. The footwear pair of claim 17, wherein the metal detecting system is a very low frequency system.

20. The footwear pair of claim 17, wherein the metal detection system includes:
an emitter coil;
a receiver coil;
a microprocessor communicatively coupled to the emitter coil and configured to generate current pulses through the emitter coil;
a sampling circuit monitoring reflected current pulses in the receiver coil and configured to generate a signal current that signals when metal has been detected based on the behavior of the reflected current pulses in the receiver coil; and
an integrator communicatively coupled to the sampling circuit and configured to amplify the signal current into an amplified current.
